(19) United States
(12) Patent Application Publication
(10) Pub. No.: US 2006/0141932 A1
(43) Pub. Date: Jun. 29, 2006

(54) Method and system for identifying coverage gaps in a wireless infrastructure

(76) Inventors: Loren Lawrence, Rogers, AR (US); Barry Ridings, Fayetteville, AR (US); Dean Kawaguchi, San Jose, CA (US); Ron Zancola, Merrick, NY (US); Paul Cowan, Hinckley, OH (US)

Correspondence Address: FAY KAPLUN & MARCIN, LLP, 15O BROADWAY, SUITE 702, NEW YORK, NY, 10038, US

(21) Appl. No.: 11/142,695

(22) Filed: May 31, 2005

Related U.S. Application Data
(63) Continuation-in-part of application No. 11/022,911, filed on Dec. 27, 2004.

(51) Int. Cl. H04B 7/00

(52) U.S. Cl. 455/41.2

(57) ABSTRACT

Described is a system which includes a wireless arrangement and a mobile unit. The mobile unit includes a wireless transducer and a data acquisition arrangement (“DAA”). The DAA obtains identification data from a marker which is situated on a permanent fixture at a predetermined location. The wireless transducer sends a transmission to the wireless arrangement. The transmission includes the identification data and wireless transmission data. The wireless arrangement analyzes the identification data to determine the predetermined location. The wireless arrangement determines wireless coverage data at the location as a function of the transmission data.

### REFERENCE TO RELATED APPLICATIONS

This application is a continuation-in-part of U.S. patent application Ser. No. 11/022,911 filed Dec. 27, 2004, entitled, “Method and System for Identifying Wireless Network Coverage Gaps.” The specification of the above-identified application is incorporated herewith by reference.

### FIELD OF THE INVENTION

The present invention relates to a method and system for identifying coverage gaps in wireless networks.

### BACKGROUND INFORMATION

Wireless networks are frequently utilized in locations in which a large number of mobile units (“MUs”) require access to the wireless network, a central server and/or a database. For example, in a retail environment, a plurality of mobile units may be used at any one time to perform routine retail inventory functions, such as retrieving data from inventory items (e.g., scanning barcodes). In the retail environment, the data may represent, for example, a number of items presently on a shelf, a location of an item within a store, etc.

Typically, the wireless network may experience problems with a radio frequency (“RF”) coverage because the wireless connections between the MUs and one or more access points (“APs”) are prone to interruptions and interference. Interruptions and interference with the RF signals to/from the mobile units may cause coverage gaps in the wireless network. Therefore, wireless network operators are forced to perform routine maintenance, including identifying and fixing the coverage gaps, which may represent significant time and cost to a proprietor of the wireless network (e.g., an owner of a retail outlet).

Conventional methods for identifying the coverage gaps generally require a user to roam around a geographical area of the RF coverage of the wireless network with a specialized monitoring device that records a signal strength of the RF signals. However, this method requires trained personnel and use of specialized equipment. Therefore, there is a need for a method to identify the coverage gaps in the wireless networks without using costly and complicated conventional methods.

### SUMMARY OF THE INVENTION

The present invention relates to a system which includes a wireless arrangement and a mobile unit. The mobile unit includes a wireless transducer and a data acquisition arrangement (“DAA”). The DAA obtains identification data from a marker which is situated on a permanent fixture at a predetermined location. The wireless transducer sends a transmission to the wireless arrangement. The transmission includes the identification data and wireless transmission data. The wireless arrangement analyzes the identification data to determine the predetermined location. The wireless arrangement determines wireless coverage data at the location as a function of the transmission data.

### BRIEF DESCRIPTION OF THE DRAWINGS

FIG. 1 is an exemplary embodiment of a system for identifying coverage gaps in a wireless infrastructure according to the present invention.

FIG. 2 is an exemplary embodiment of a method for mapping a wireless network according to the present invention.

FIG. 3 is an exemplary embodiment of a method for identifying coverage gaps in a wireless network according to the present invention.

### DETAILED DESCRIPTION

The present invention may be further understood with reference to the following description and the appended drawings, wherein like elements are provided with the same reference numerals. The present invention provides a system and a method for identification of coverage gaps in a wireless infrastructure (e.g., a wireless local area network “WLAN”). An exemplary embodiment of the present invention will be described in the context of a retail environment, however, one skilled in the art will understand that the present invention is not limited to such an environment, but may be utilized in other locations that employ wireless infrastructures.

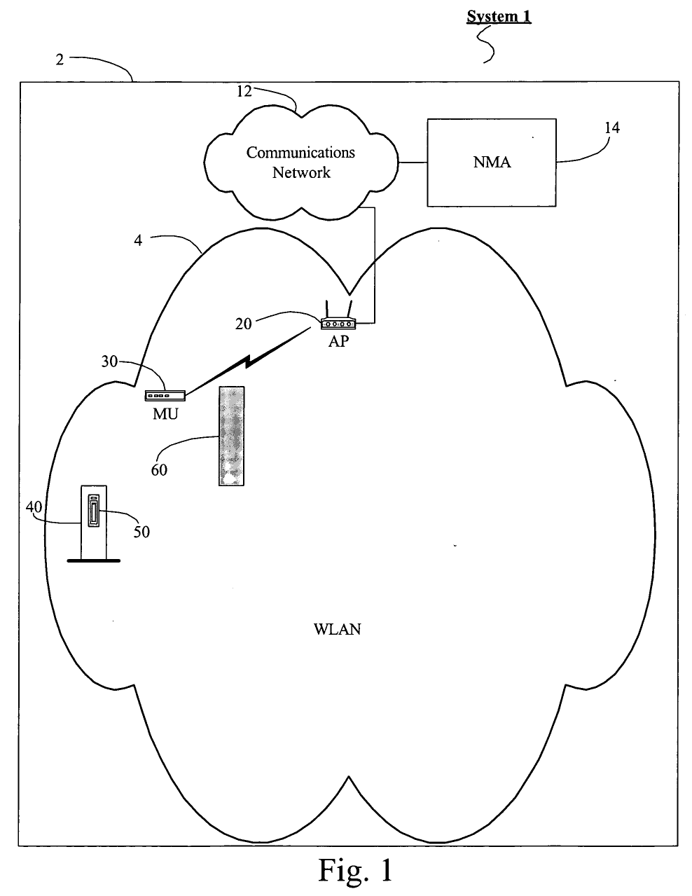

FIG. 1 shows an exemplary embodiment of a system 1 for identifying coverage gaps in a wireless infrastructure according to the present invention. The system 1 may include a network management arrangement (“NMA”) 14 connected to a communications network 12. The communications network 12 may allow one or more WLANs 4 to access the NMA connected thereto. The WLAN 4 may include an AP 20 which provides wireless connections for an MU 30 to the communications network 12.

Those skilled in the art will understand that the WLAN 4 may include a plurality of APs. The AP 20 may be a wireless infrastructure device (e.g., a wireless hub, router, switch, etc.) connected to the communications network 12 that provides wireless network access to devices on the WLAN 4. Thus, the WLAN 4 allows the MU 30 to be connected to the communications network 12 through the AP 20.

The communications network 12 may be any communications network comprising a plurality of infrastructure components which interconnect computing devices (e.g., hubs, switches, servers, etc.). The communications network 12 is connected to the NMA 14, which may be located within or outside of a store 2. The NMA 14 may include a computing arrangement for sending and receiving data requests (e.g., a server, database, router, etc.).

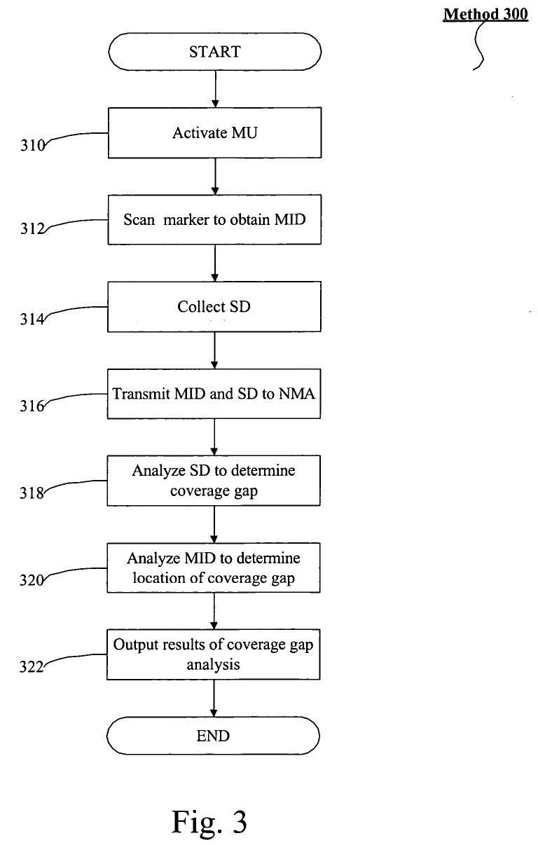

The NMA 14 may be responsible for managing the communications network 12 of the store 2, or the NMA 14 may be a centralized NMA having a broader scope. That is, the store 2 may be only one of a plurality of retail outlets, and the NMA 14 manages the networks of all of the stores from a central location. In an exemplary embodiment, the NMA 14 may be responsible for managing the communications network 12 and the WLAN 4. For example, the NMA 14 may store data about the communications network 12 and the WLAN 4. The data may include an operational status of the APs and the MUs, an RF coverage area of the APs, MAC addresses of the APs and the MUs, etc. This data may facilitate management of the WLAN 4. For example, if certain APs are not operational, the NMA 14 is notified so that appropriate action may be taken (e.g., repair or replacement of the faulty AP). In addition, the NMA 14 may be configured to receive information about the status of the RF coverage of the WLAN 4 from the MUs, as shown in FIG. 3 and discussed in more detail below.

According to the present invention, the system 1 may be implemented in a defined environment, such as the store 2, a warehouse, a supermarket, etc. The store 2 may include a movable shelf 60 on which merchandise is arranged for display and sale therein.

The merchandise and/or a package containing the merchandise may include a tag which identifies and/or contains data regarding the merchandise (e.g., price, inventory location, store location, universal product code (“UPC”)). The tag may be, for example, a barcode or an RFID tag.

The store 2 may also include a permanent fixture 40 on which a marker 50 is placed. The permanent fixture 40 may be any feature in the store 2 which does not or cannot be moved such as, for example, a column, wall, beam, pole, etc. The marker 50 may be made of a plastic material and attached using an adhesive material.

Those skilled in the art will understand that the store 2 may include a plurality of fixtures upon which markers 50 are placed. The marker 50 may be substantially similar to the tag (e.g., a barcode, an RFID tag) used to identify the merchandise, except that the marker 50 identifies or contains location information rather than merchandise information. For example, the marker 50 may include information enabling a location of the permanent fixture 40 to be determined. As understood by those skilled in the art, the marker 50 may be positioned anywhere on the permanent fixture 40, but is preferably in a readily visible or an easily accessible location. For example, the marker 50 may be placed at or around eye level.

The MU 30 may be a mobile computing device that includes a data acquisition arrangement (“DAA”) to obtain and/or modify the data about the merchandise and the markers. For example, if the tag or the marker 50 are barcodes, the MU 30 may include an optical scanner for reading the barcodes. If the tag or the marker 50 are RFID tags, the MU 30 may include an RFID interrogator. Furthermore, the MU 30 may include additional circuitry and a processing arrangement allowing the MU 30 to perform its functions (e.g., scanning, modifying the merchandise data, etc.). The MU 30 may further include a wireless transducer allowing it to communicate with the AP 20 according to a wireless communications protocol (e.g., IEEE 802.11a-g protocols, etc.). In this manner, the MU 30 may transmit/receive RF signals to/from the AP 20, thereby allowing the MU 30 to access the NMA 14 and other devices that may be connected to the communications network 12.

In the exemplary embodiment of the present invention, the NMA 14 may store data pertinent to the WLAN 4 of the store 2. For example, the NMA 14 may include information regarding a physical layout of the store 2. In addition, the NMA 14 may include information regarding the marker 50 (e.g., a location and a corresponding previously measured signal strength, etc.). More specifically, the NMA 14 contains information about the location of the marker 50 within the store 2 (e.g., a coverage map showing the location of the marker 50).

According to the present invention, the NMA 14 may detect coverage gaps in the WLAN 4 using one or both of two types of data, a location data and a signal data (“SD”). The location data may include a position of the MU 30 within the store 2 obtained by, for example, comparing a marker identification data (“MID”) collected by the MU 30 with a coverage map of the store 2 stored within the NMA 14. The MID may include an identity of the marker and a record of the location of the marker 50 (e.g., a set of coordinates on the coverage map).

The SD may include a status report on the quality and/or availability of the wireless connection between the MU 30 and the AP 20. In addition, the SD may further include ping data between the MU 30 and the WLAN 4. The NMA 14 combines the location data with the SD to determine an RF coverage of the WLAN 4. Thus, the existing infrastructure of a retail environment may be used to determine a location of the RF coverage of the WLAN 4 within the store 2.

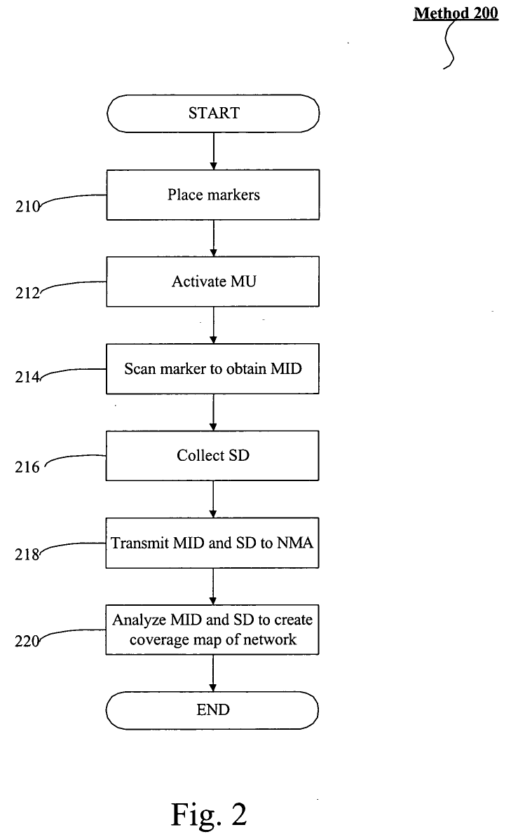

FIG. 2 shows an exemplary embodiment of a method 200 for mapping wireless networks according to the present invention. In step 210, the marker 50 is placed onto the permanent fixture 40 by a user or a network technician. In some embodiments, locations of the marker 50 and any other markers are evenly spaced throughout the store 2. In other embodiments, the locations may not be evenly spaced. For example, more markers may be placed in an area of the store 2 which is subject to frequent RF coverage changes or is more actively used than other areas of the store 2.

In step 212, the user activates the MU 30. The activation may include powering up the MU 30, waking it from hibernation, or logging in the user. The activation process may also include selecting the store 2 and/or a subsection of the store 2 in which the user intends to use the MU 30. User-entered location data is less desirable than automatically obtained location data as discussed below. Therefore, user-entered location data may be a redundant component of a location-obtaining method whereby the user-entered location data is subsequently verified by the MU 30 and the NMA 14.

In step 214, the MU 30 obtains the MID by, for example, scanning the marker 50. The scanning may be initiated by the user or may be performed automatically when the user is within a predetermined range of the marker 50. Prior to collecting the MID, the MU 30 may prompt the user to verify that the location of the scanning is the same as the location entered by the user in step 212. The MID is later transmitted to the NMA 14 for analysis as discussed below.

In step 216, the MU 30 obtains the SD. The SD may include RF statistics related to the WLAN 4 (e.g., signal strength, device identification, etc.). For example, if the WLAN 4 is based on the Spectrum 24 protocol available from Symbol Technologies, Inc., Holtsville, N.Y., the MU 30 may collect and record the following signal strength statistics which the Spectrum 24 protocol facilitates: a received signal strength indicator (RSSI) of a receiver, a percent of beacons missed by the MU 30, a percent of cyclic redundancy check (CRC) errors of the receiver, and a percent of attempted retransmissions. The RSSI provides a measurement of the strength of the RF signals. The CRC errors may indicate that the connection between the AP 20 and the MU 30 is poor, because the MID became corrupt.

In addition to signal strength statistics, the MU 30 also obtains infrastructure identifying information about the devices on the WLAN 22. For example, the MU 30 may record the MAC addresses, basic service set identifiers (“BSSIDs”) and service set identifiers (“SSIDs”) of itself and the AP 20, depending on which identifiers are utilized. Furthermore, the MU 30 may also record other identifying information, for example, an identity of the store 2, if the store 2 is one of a plurality of outlets. The infrastructure identifying information allows network managers to determine which devices on the WLAN 4 or the communications network 12 are responsible for RF signal failures.

The MU 30 may further determine and obtain ping data. Those skilled in the art will understand that the MU 30 may be configured to perform various tests on the WLAN 4 and the communications network 12. Ping data is similar to the RF SD because it provides information concerning the connection of the MU 30 to the WLAN 4 and/or the communications network 12. To obtain ping data, the MU 30 may perform ping tests on various devices on the communications network 12 or the WLAN 4 to determine the transmission time for the ping (e.g., 3 ms) or if a connection even exists (i.e., ping timeout denotes there is no connection). Results of the ping tests may be recorded and saved in a file on the MU 30.

In certain situations, the MU 30 may not have a wireless connection because it may be outside the coverage of the WLAN 4, or the AP 20 may not be operational. Therefore, the MU 30 may not be able to obtain any radio frequency statistics or the ping data. In this case, the SD may include data indicating that the MU 30 was unable to connect to the WLAN 4 and/or the AP 20. However, the MU 30 may obtain the ping data from the AP 20 even if, for example, the NMA 14 appears gone (e.g, routing between WLAN 4 and the NMA 14 has been removed). That is, the AP 20 may remain pingable.

In step 218, the MID and the SD are transmitted to the server 8. Prior to transmission, collection of the MID and the SD may be terminated. Termination of recording process may be automatic (e.g., once the user finishes scanning the marker 50 the collection is terminated) or manual (e.g., scanning continues until the user terminates the scan). Once the scanning process is terminated the MID and the SD are transmitted to the NMA 14 via the communications network 12.

In a further exemplary embodiment of the present invention, the MID and the SD are transmitted to the NMA 14 upon reaching a predefined condition (e.g., a number of scans, time, etc.). Thus, the user of the MU 30 may be unaware that the MID and the SD are being transmitted to the NMA 14.

The data transmission from the MU 30 to the NMA 14 may be either through a wireless connection (e.g., through the WLAN 4) or a wired connection. The MU 30 may transmit data files using the AirBEAM available from Symbol Technologies, Inc. Preferably a wireless connection is used, however, where a wireless connection is unavailable (e.g., the MU 30 is outside the coverage of the WLAN 4, the AP 20 is not operational, etc.) a wired connection may be used as a substitute. If a wired connection is used, the data collected during the steps 214 and 216 is transmitted from a different location and at a later time, such as when the MU 30 is connected to the communications network 12 (e.g., docked at a computer terminal connected to the communications network 12).

Furthermore, the transmission step may be used to provide additional information for the SD. For instance, if during an attempted wireless transmission through the AP 20, the MU 30 discovers that it no longer has a wireless connection, that disruption in the connection would be added to the SD creating an augmented SD. The augmented SD containing the failed transmission would be transmitted using a wired connection as discussed above.

As the data collected by the MU 30 is relayed to the NMA 14 through various WLAN 4 components (e.g., the AP 20) and/or infrastructure components of the communications network 12, the transmission may be timestamped to provide additional SD. For example, as the MU 30 transmits the collected data it would add the date and time of the transmission. The AP 20, upon the receipt of the data would include the date and time for that activity, as well as include the date and time that the data was relayed to the communications network 12. The timestamps may supplement the SD because they provide information on a total time that a transmission from the MU 30 takes to reach the NMA 14.

In step 220, the NMA 14 processes and analyzes the MID and the SD transmitted from the MU 30 to create a coverage map of the store 2. As understood by those skilled in the art, the NMA 14 may store the transmitted MID and the SD locally allowing the MU 30 to delete the data stored therein since the MU 30 storage capabilities may be limited. The data may be stored on the NMA 14 based on a predetermined directory structure. For example, the data from the MU 30 may be sorted based on the MAC address of the MU 30. In addition, if the MU 30 has previously transmitted files to the NMA 14, the NMA 14 may store the files in a directory corresponding to the MU 30 without overwriting previous files. Such storage allows the NMA 14 to maintain an organized record of the MID and the SD which may be used to prepare long-term comprehensive wireless connection analyses.

After the coverage map has been created, the system 1 is ready to begin operations, including detection of coverage gaps as will be described below. Following the creation of the coverage map, the RF coverage of the WLAN 4 may change, resulting in coverage gaps. This coverage change may be caused by, for example, modifying the physical layout of the store 2 (e.g., moving the shelf 60, adding and/or removing objects from the store 2, etc.). The coverage change may also be a result of interference among the devices in the WLAN 4 or between the devices and other external devices such as MUs from a nearby store. Thus, it is preferable that the method 200 is performed when the store 2 is completely empty or at least substantially free of movable fixtures, products, etc. so that the wireless coverage of the store 2 can be accurately measured.

FIG. 3 shows an exemplary embodiment of a method 300 for identifying coverage gaps in a wireless network according to the present invention. Steps 310-316 correspond to steps 212-218 of method 200. As previously discussed, MID and SD collection and transmission may be user initiated or automatic, and may in addition be initiated in response to an operation performed on a merchandise (e.g., scanning an item, updating an item, etc.).

In step 318, the NMA 14 has received the MID and SD from the MU 30 and analyzes the SD to determine whether the coverage gap exists. The NMA 14 compares the SD to acceptable parameters. For example, if the RSSI is below a preset parameter or if there were more CRC check failures than allowed by a network setting, the NMA 14 may note that there is a signal fault within the WLAN 4. In addition, if the MU 30 could not transmit the collected data through the wireless connection, the NMA 14 would indicate that there was a critical failure in the RF coverage of the WLAN 4.

The NMA 14 analyzes the ping data and timestamps to determine the stability of the wireless connection between the MU 30 and the communications network 12. This allows for analysis of infrastructure components which are part of the communications network 12. Thus, the ping data and timestamps allow the NMA 14 to identify connectivity problems caused by the communications network 12, as well as the WLAN 4. In addition to the above-identified data, the NMA 14 parses the infrastructure identifying information transmitted from the MU 30 in order to determine which devices on the WLAN 4 or the communications network 12 are responsible for signal failures. The infrastructure identifying information also allows the NMA 14 to properly sort and store the received data.

In step 320, the NMA 14 analyzes the MID to obtain location data and determine the position of the coverage gap within the WLAN 4. As discussed above, the NMA 14 stores the location of the marker 50. Thus, if the NMA 14 is aware that the MU 30 was scanning the marker 50, the NMA 14 can determine the location of the MU 30 in relation to the location of the marker 50. This allows the NMA 14 to determine the location of the coverage gap within the WLAN 4, because the location of the MU 30 may correspond to the location of the coverage gap by combining the SD and the location of the MU 30 during scanning. Since the SD designating the coverage gap was obtained during scanning of the marker 50, the server 8 can determine that the coverage gap exists at the location of the scanning activity.

In step 322, after analyzing the coverage gaps, the NMA 14 may output the analysis for network managers. Those skilled in the art will understand that output of the analysis may be in a plurality of formats (e.g., print out, saved file, display, etc.). The output allows network managers to take appropriate action in response to the identified coverage gaps in the WLAN 4 (e.g., install additional APs, extend existing coverage of the APs, etc.).

The present invention utilizes the existing infrastructure of the retail environment (e.g., APs, scanners, marker location, etc.) to identify gaps in the wireless network coverage. The NMA 14 determines whether the coverage gap exists based on the SD and where that coverage gap occurred based on the location data. After the network has been setup and the coverage map created, no specialized equipment or additional components are required, thereby minimizing the cost and time involved in re-mapping and maintaining the WLAN 4.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A system, comprising:
a wireless arrangement; and
a mobile unit including a wireless transducer and a data acquisition arrangement (“DAA”), the DAA obtaining identification data from a marker which is situated on a permanent fixture at a predetermined location,
wherein the wireless transducer sends a transmission to the wireless arrangement, the transmission including the identification data and wireless transmission data, and
wherein the wireless arrangement analyzes the identification data to determine the predetermined location, the wireless arrangement determining wireless coverage data at the location as a function of the transmission data.

2. The system according to claim 1, wherein the wireless arrangement is one of an access point, a wireless hub and a wireless switch.

3. The system according to claim 1, wherein the mobile unit is one of a barcode scanner and an RFID interrogator.

4. The system according to claim 1, wherein the marker is one of a barcode and an RFID tag.

5. The system according to claim 1, wherein the wireless transmission data is at least one of a received signal strength indicator, a predetermined number of missed beacons, a predetermined number of cyclic redundancy check errors, a predetermined number of retransmissions, a ping data and a timestamp.

6. The system according to claim 1, wherein the transmission further includes mobile unit identification data.

7. The system according to claim 6, wherein the mobile unit identification data is at least one of a MAC address of the mobile unit and a service set identifier of the mobile unit.

8. The system according to claim 1, wherein the wireless coverage data is determined by a comparison of the transmission data and stored transmission data on the wireless arrangement.

9. The system according to claim 8, wherein the stored transmission data is a threshold value of at least one of a received signal strength indicator, missed beacons, cyclic redundancy check errors, retransmissions and ping data.

10. The system according to claim 9, wherein, when the transmission data is below the threshold value, the wireless arrangement indicates that a coverage gap exists at the predetermined location.

11. A method, comprising:
receiving a transmission generated by a mobile unit, the transmission including identification data and wireless transmission data, the identification data obtained from a marker situated on a permanent fixture at a predetermined location;
analyzing the identification data to determine the predetermined location; and
determining wireless coverage data at the location as a function of the transmission data.

12. The method according to claim 11, wherein the mobile unit is one of a barcode scanner and an RFID interrogator.

13. The method according to claim 11, wherein the marker is one of a barcode and an RFID tag.

14. The method according to claim 11, wherein the wireless transmission data is at least one of a received signal strength indicator, a predetermined number of missed beacons, a predetermined number of cyclic redundancy check errors, a predetermined number of retransmissions, a ping data and a timestamp.

15. The method according to claim 11, wherein the transmission further includes mobile unit identification data.

16. The method according to claim 15, wherein the mobile unit identification data is at least one of a MAC address of the mobile unit and a service set identifier of the mobile unit.

17. The method according to claim 11, wherein the determining step further includes:
comparing the transmission data and stored transmission data.

18. The method according to claim 17, wherein the stored transmission data is a threshold value of at least one of a received signal strength indicator, missed beacons, cyclic redundancy check errors, retransmissions and ping data.

19. The method according to claim 18, wherein the determining step further includes:
when the transmission data is below the threshold value, indicating that a coverage gap exists at the predetermined location.

20. A system, comprising:
a wireless arrangement; and
a mobile unit including a wireless transducer and a data acquisition arrangement (“DAA”), the DAA obtaining identification data from a marker which is situated on a permanent fixture at a predetermined location,
wherein the wireless transducer sends a transmission to the wireless arrangement, the transmission including the identification data and wireless transmission data, and
wherein the wireless arrangement analyzes the identification data to determine the predetermined location, the wireless arrangement determining an existence of a coverage gap at the location as a function of the transmission data.
